(19) United States
(12) Patent Application Publication
(10) Pub. No.: US 2015/0238871 A1
(43) Pub. Date: Aug. 27, 2015

(54) GAMIFICATION AND COMPUTERIZATION OF ON-LINE PHOTO IDENTIFICATION

(71) Applicants: Howard A. Green, Palm Beach, FL (US); Joseph Gene Cannata, JR., Cary, NC (US)

(72) Inventors: Howard A. Green, Palm Beach, FL (US); Joseph Gene Cannata, JR., Cary, NC (US)

(21) Appl. No.: 14/469,493

(22) Filed: Aug. 26, 2014

Related U.S. Application Data
(60) Provisional application No. 61/944,534, filed on Feb. 25, 2014.

(51) Int. Cl. A63F 13/79

(52) U.S. Cl. CPC A63F 13/79

(57) ABSTRACT

A method of participating in an identification game includes the steps of providing information on an interface executed by a computer program interacting with at least one and preferably several lay website visitors or other interface visitors or members of the general public, which upon joining the website or other interface are referred to herein simply as lay subject matter identifiers members, or as a lay subject submitting member who has provided the photographic image for identification, or as an identifying member who views and submits an identification of what is shown in the photo, which in most instances would be a digital image or picture of something, to identify what specifically beyond the category of the subject matter is shown in the photo.

This application continues from provisional patent application Ser. No. 61/944,534, filed on Feb. 25, 2014.

### BACKGROUND OF THE INVENTION

### Field of the Invention

The present invention relates generally to the field of computerized on-line games. More specifically the present invention relates to an on-line photo identification game for game participants including photo submitting participants and photo identification participants. The game operates on the principle that collective intelligence, such as that provided by a several photo identification participants, will most likely provide a highly reliable identification of what is shown in the image in the photo, referred to herein simply as photo identification. The identification is in most instances simply a name of what is in the photo, but in some instances may be a fuller description of what is in the photo, as long as the description lends itself to ready comparison with other submitted photo identifications so that the concurrence with other photo identification participants can be determined readily such as by the website program.

The subject shown in the photo is considered within a subject matter category, such as a type of bird or plant is in the photo, a city, a street, a building, a river or a mountain range anywhere in the world or a region of the world, an astronomical object, a heavenly body or a phenomenon, an agricultural disease in a crop, an insect or an animal, a dental condition of the oral cavity, a condition a type of historical a artifact, a antique or a fossil, or a postage stamp, a work of art, or a collectable coin.

Numerous front end interfaces are suitable for leveraging the back-end logic and data defining this game. Therefore, the word “interface” is used hereinafter to represent any and all suitable front end interfaces, including but not limited to a website or an App such as iOS App, a Web App, an Android App or other app.

The game includes the method steps of creating an interface such as a for the on-line game having an interface program; receiving photos from on-line submitting participants relating to a certain topic or subject matter; the interface copying the photos to on-line photo identification participants for identification; each photo identification participant submitting through the interface his or her best evaluation and resulting identification of what is shown in the photo; the interface determining the most common identification and optionally in addition determining the second most common identification of what is in the photo from the identifications submitted by the participating photo evaluation participants; and the interface sending to the submitting participant of the given photo the most common and optionally in addition the second most common photo content identification. Game participants, particularly photo identification participants, may be required to be professionals in a given field who are credentialed by the interface for game participation, or may be anyone believing they have knowledge of the given field or who simply wish to participate.

Another step is storing the photo and its identification(s) in a photo and text interface database which for example may be called a wikiphotoatlas for future reference for educational and other uses. Further additional steps include matching explanatory text to the most or second most submitted identification for the given photo, the text preferably being drawn from the interface database, and sending this matched text to the photo submitting participant who supplied the given photo to further educate him or her about what is in their photo.

The submitting participants and the photo identification participants may be the same people, and all participants receive points for their participation so that a winner can be determined or compensation optionally can be awarded, or both. Points may be granted for submitting a photo for identification, for participating in a photo identification and for submitting an identification of a photo that the interface determines is among the most common for the given and optionally receiving points for submitting an identification of a photo that the interface determines is among the second most common for the given photo, since concurrence with a majority is considered an indication of a correct or well considered identification. Points may also be granted for editing text stored in the photo and text data base.

Where the photo is of part of a human body appearing to show a condition, the identification of which is in the photo. It is not a medical diagnosis because diagnosis requires a history of the photo and other related details which are used in the judgment of a doctor. It is not practicing medicine because there is no definitive diagnosis, there is no physician patient relationship and there are no pharmaceutical or surgical treatments being prescribed. Therefore this remains solely a game of photo identification. Therefore this remains an identification game, and never represents or substitutes for the judgment of a doctor in relation to a given patient and as a result does not constitute the practice of medicine.

More specifically, the method includes the steps of providing information on an interface executed by a computer program interacting with at least three and preferably several more lay interface visitors or members of the general public, which upon joining the website or other interface are referred to herein simply as members, or as a submitting member who has provided the photographic image (hereinafter photo) for identification, or as a identifying member who views and submits an identification of what is shown in the photo, which in most instances would be a digital image or picture of something, to identify what specifically beyond the category of the subject matter is shown in the photo. It is understood that there may be members who at any given moment are not submitting or identifying, and therefore may be merely viewing members. At any given time a member may be any one, two or all of: a viewing member, a submitting member and an identifying member. Non-members may or may not also be permitted to view identifications. The something requiring specific identification may fall into and one or a combination of the following categories, or into other categories such as coins, stamps, birds, cars, geographic features, guns, buildings, architecture, insects, people, plants, animals, rocks, trees, horticulture, artwork, logos, and a variety of photos captured images associated with a variety of amateur and professionals hobbies, passions, pursuits and professions.

The method includes the essential steps of: an interface visitor accessing the program on a computer; the interface visitor becoming a member of text match service to gain further access to the program; the member automatically being subscribed to a queue henceforth known as the textmatch or photoidentification queue; the customer generating or acquiring at least one photo of something; the member entering an identification of the content of the image of which the photo was taken; the submitting member uploading to the program the photo(s); the program assembling the photo(s) into a collection known henceforth as a photobook; the program publishing the photobook to the photo queue; the program assigning a unique identifier to the photobook, the program making the photobook anonymous by secreting the unique identifier which connects the photobook to the submitting member; the program making the photobook readable on the photo queue; several identifying members subscribed to the photo queue retrieving the photobook from the queue; several identifying members viewing the photobook and identifying what is in the images(s) shown in the photo(s); the identifying members matching the photobook to stored texts identifying or describing the identified photo or the members simply naming what is in the photobook photos; the program storing all matches associated to the photobook; the program determining the two leading text matches or names of what is shown in the photo as selected most frequently by the identifying members; the program publishing the photobook in combination with the two leading matched texts to the textmatch queue; the program notifying the submitting member that the match is complete via one of: app notification badge, account notification badge on the program driven website or other interface, cell phone text, short message service, apple imessage, email, postal mail and telefax; submitting member viewing the identifications and textmatches associated to their photobook from the textmatch queue; the program conveying photobooks to a wiki based photo atlas for the continuing education of users of the service as well as for potential research; the program calculating identifying member standings based on concurrence with the majority; the program identifying top rated identifying members in multiple categories to be rewarded for participation and concurrence with the majority.

Becoming a Member

The basic method, including additional preferred steps, is as follows: an interface visitor such as a website visitor (visitor) accessing the program; the visitor requesting membership; the program displaying user terms and conditions and a disclaimer; the visitor entering a decision of whether he or she accepts the terms and conditions and disclaimer; if the visitor rejects the terms and conditions and disclaimer, the program rejecting the visitor and ending his or her use of the program; and if the visitor accepts the terms and conditions and disclaimer; and the program creating a member profile and the visitor becoming a member.

Submitting Photos

The steps further include an interface visitor such as a website visitor accessing the program; the program prompting the interface visitor to submit identifying information to determine whether the interface visitor is a member; if the program determines that the website visitor is not a member, the program directing the interface visitor to the prompt to become a member; if the program determines that the interface visitor is a member, the program prompting the member to upload at least one photo of something to be identified and thereby becoming a submitting member; the submitting member uploading to the program the photo(s); the program assembling the photo(s) into a photobook; the program publishing the photobook to the photo queue; the program assigning a unique identifier to the photobook, the program making the photobook anonymous by secreting the unique identifier which connects the photobook to the submitting member; the program making the photobook readable on the photo queue; If the photo is rejected by the majority of identifying members, the program notifying the submitting member that a photo resubmission is required; the submitting member uploading a replacement photo; if the replacement photo is acceptable, the program anonomizing and publishing the photo the ID queue; the program providing the submitting member with an image ID or textmatch; and the program proceeding to photo ID and textmatch.

Photo Textmatch

For purposes of this application, a photo is described as “good” if the image it displays is sufficiently clear that the content of or subject shown in the image can be identified by a photo identifying member or photo identifying interface visitor (photo identifying visitor). If the photo identifying member is not logged in, the steps further include the identifying member logging in; if the identifying member is logged in, the program presenting photobooks to the identifying member and the identifying member reading photobooks from the photo queue; if no more photos are to have their images identified, the member logging out, or the member logging in to read another photo; if more photos are to be identified, the identifying member determining whether the photos are good; if the identifying member determines that the photos are not good, the identifying member and program recommending how to improve the photos; the program determining whether the majority of identifying members say that the photos are good; if the majority of identifying members say that the photos are not good, the program rejecting the photo with recommendations for technical improvements; if the individual identifying member says that the photo is good, the identifying members matching the photobook to stored texts identifying or describing the identified photo or the members simply naming what is in the photobook photos; the program storing all al names and matches associated to the photobook; the program determining the two leading names and possibly text matches of what is shown in the photo as selected most frequently by the identifying members; the program publishing the named photobook in combination with the two leading matched texts to the textmatch queue; the program notifying the submitting member that the match is complete via one of: app notification badge, account notification badge on the program driven website or other interface, cell phone text, short message service, apple imessage, email, postal mail and telefax; the program recording participation and concurrence in their profiles for statistical analysis; the program determining quality control and optionally determining and providing reward compensation; the program placing the identified photos in the wiki based photo atlas for interface users further discussion and education.

Return Textmatch

Proceeding from the photo atlas textmatch, the program performs the steps of: targeting advertising based on photo identification, associated textmatches, affiliations, account type and geography; the program determining whether to send photos to the wiki based photo atlas, or in other words storing the photo in a permanent depository; if yes persist photos to wikphotoatlas repository, the program sending a photo to wiki; if no do not persist photos to repository, the program discarding user data from the online database and not conveying to a repository such as wiki based photo atlas.

Quality Control and Compensation

Data from member profiles; the program rating identifying members on frequency of participation, concurrence with the majority of identifying member votes, number of photograph submissions and referrals, and wiki based photo atlas text entries; the program optionally compensating the top identifying members or affiliates based on their ratings thereby creating a competition; the program updating identifying member profiles with rating / quality control results (concurrence with majority); the member viewing quality control and compensation results; the member logging out; the program ending his or her use of the subprogram; a viewing member logging in; the viewing member viewing quality control and any competition reward compensation results; the member logs out; the program ending his or her use of the subprogram. For the above version, any member can be a submitting member, a identifying member or both.

Variation of Method

A variation of this method is provided, which is identical to the method described above, with the following exceptions. First, in place of unrestricted lay-public members as broadly defined above competing in this game by submitting photos for identification, concurrence with the majority and entering content into the wikiphotoatlas, only credentialed professionals will be accepted as identifying members and thus be provided access to the interface/program submit, view and identify images. The term “professionals” can mean anyone with credentials supporting professional knowledge of the photo subject matter to be identified, such as researchers in the field and university professors. To distinguish the professionals who are provided access to the program to identify submitted images for evaluation an advisory board will form with these professional only credentialed members. That is, as previously noted, professionals on the advisory board, or advisory board members, or otherwise facilitating the operation of the photo identification program such as an accessing health care professional is referred to in the claims as an photo submitting health care professional and shall be credentialed accordingly by the program. It is further preferred that the photo submitting health care professionals may be identified according to those who are invited or referred, and or subsequently credentialed by the interface operators and the program to access or join this professionals-only submitting version of the website or other interface, such an invitation and credentialing being a method step and the new accessing professional shall identify the board member who referred him or her in order to reward the board member. Second, for professional members only, the advisory board members provide identification of what is shown in the submitted photo which will be subsequently matched to corresponding text. The term “identification” as used here and in the claims is understood to mean the name of the object or condition in the photo as identified by a highest number of votes of the professional advisory board competing in the game. This is preferred because, when presented with a name of a condition represented on a photo, a photo submitting professional will understand what the name means and what the associated condition or subject of the photo is and normally will not require an associated explanatory text along with the results of the identification vote. In addition, submitting professionals are educated in performing associated subject matter text searches, unlike the lay public and therefore may only receive the results of the board vote, without an associated text match from the wikiphotoatlas. Applicant does, however, contemplate the option of providing specialized matching text for the submitting professional in addition to the identification of the image in the photo. This specialized matching text preferably originates from the wiki based photo atlas long term repository constructed in crowd sourced manner via the wiki web interface. The emergence of the Internet and the recent developments in online collaborative technologies has provided new tools with which to find, use, share and expand knowledge. Wiki technologies challenge the traditional notions of authorship, editing and publishing and have the inherent potential to change how we construct knowledge repositories and collaborate on the Web. Despite the extraordinary success of Wikipedia and the potential of wiki publishing, its adoption in the academic community and within the field of education of professionals and non-professionals has been limited and almost non-existent. Therefore, our wiki based photo atlas is a novel educational tool.

In contrast to conventional static publications, dynamic publications in the wiki model have no final version, no definite date of publication and continuously integrate and synthesize new findings and insights. We will also develop a dynamic collaborative knowledgebase using wiki technology that combines a continuous stream of submitted photos and merges it with referenced content created by authors from our credentialed (in the case of professions) and non-credentialed (in the case of hobbies, pursuits and passions and interests) board of advisors, with due credit given and rewarded for ongoing revisions and integration of more traditional peer review models into a rigorous clinical, educational and research tool. Our online method will integrate a wiki based photo atlas into both our professional only and lay public accessed websites or other interfaces. The wiki based photo atlas will receive the photographs identified by the Board of Advisors or the lay users registered on the site which have been submitted to the website or other interface. Professional's only and non-professionals who are registered to participate on either the Professional Board of Advisors or as lay photo subject matter identifiers will be able to access and edit the wikiphotoatlas text content in order to publish and continuously construct a real time, up to date collaborative dermatology knowledge repository on the web. Board members and lay users who contribute to the wikiphotoatlas will be rewarded for their efforts and therefore a competition or game for participation in the education information process will be created.

An example of the game where the subject matter requires a professional is skin photo identification is as follows. The subject matter of the photo contents may be, for example, the skin, hair, mucosa or nail of either the submitting member him or herself or another person, in which the image appears to containing an anomaly requiring identification. In this instance it is required that the identifying member is a health care professional such as a doctor, physician's assistant, nurse, nurse practitioner or in some instances a medical technician, and these credentialed identifying members become part of the advisory board competing by identifying photos. For this example, the wikiphotoatlas is a wikiskinatlas.

### Description of the Prior Art

There previously have been games or non-game related mechanisms involving storing and displaying photographic images. Examples of these known to applicant include Sigle, U.S. Pat. No. 5,056,793, issued on Oct. 15, 1991, which discloses a picture identification game for several players. The Sigle game involves providing a picture such as a photo containing an image and entirely covering the image with cover pieces, and then removing the cover pieces one by one until a player correctly identifies the image in the picture. Identification is not done through multiple people submitting their own identifications and using this collective intelligence to arrive at the most reliable answer. Rather, the correct answer is already known with certainty in advance, but not to the players. The players are not evaluating an entire image, but instead a partially obscured image, so that the challenge is not in recognizing the image itself but rather in trying to discern what remains hidden.

Wolff, et al, U.S. Pat. No. 6,833,848, issued on Dec. 21, 2004, teaches a game console based digital photo album. This game does not involve using collective intelligence to identify the content of a photo. Wolff, et al., includes steps of storing and displaying photo images in a track and navigating through the stored images, displaying authored stories in second and third tracks, one of the stories in the third track being a story being created, enabling the user to edit the story and selecting background music to accompany the story and image using a game controller with a joystick.

Pilu, U.S. Patent Application Publication Numbers U.S. 2002/0126159 and U.S. 2002/0128062, both published on Sep. 12, 2002, reveal what are titled digital image viewings I and II. Pilu is a system in which a personal digitalized photo supplied by a user is displayed, a gaming console fro playing a video game is provide, and domestic television set for displaying the video game and the personal digitalized photo, which permits simultaneous viewing of the photo at remote locations. Means for altering or enhancing the photo are provided, and well as means for storing the photo permanently. Photo image identification apparently is not provided.

Golden, et al., U.S. Patent Application Publication Number U.S. 2004/0208343, published on Oct. 21, 2004, discloses an apparatus and method for creating a record using biometric information. Golden, et al. is not a game, but simply involves creating an identification record of specific, individual animals which may include a photo of one or more identifying features of the animal to aid in identification.

Wallach, U.S. Patent Application Number 2002/0145253, published on Oct. 10, 2002, teaches a family or household chore system game. The Wallach game is a household chore doing competition, in which the member of the household who does the most and most difficult chores wins and gains recognition as the “Family Member of the Month”. No photo identification appears to be involved.

Pearlman, U.S. Patent Application Number 2004/0014524, published on Jan. 22, 2004, reveals a trivia and memory game using multimedia clips having visual and audio components. Each multimedia clip is associated with several potential questions, and a clip is randomly selected for presentation to several players. A question for each clip is also randomly selected for presentation to all of the players, and players gain points depending on whether they answer each such question correctly and on how rapidly they give their answers. The questions are provided with multiple choice answers. The clips may be taken from movie, television, sports and news videos. Since there are several questions from which only one is randomly selected for each clip, the question in most instances and possibly all instances will not be that of simply asking for identifying the image in the photo. Furthermore, collective intelligence apparently is not brought to bear to identify what is shown in a photo.

Odake, U.S. Patent Application Publication Number 2002/0004419, published on Jan. 10, 2002, discloses a photographing game machine and game processing method and information storage medium. A camera-type input device permits a subject included in a photo shooting range to be seen through a window. A game screen including a target to be photographed is displayed. The camera-type input device includes a shutter switch through which the player provides instructions to take a photograph. Thus Odake appears to be a photographing game rather than a photo identification game.

What is absent in the prior art is a game in which an image not previously identified is identified, and further where this is done through the application of collective intelligence.

It is thus an object of the present invention to provide an interface such as a website and an interface program such as a website program in which a photo identification game can be played, which for one example of the game involves a computer program in which photos and information are conveyed by at least one submitting member to several identifying members, which for one version of the game are lay persons or members of the public in general which may mix lay or professional people, and for another version are professionals referred to herein as advisory board members, from a submitting member who has provided the submitted photo(s) for the purpose of seeking information from the identifying members about the image or content depicted in the photo(s), and thus one version is the first professionally guided search engine using collective or group intelligence.

It is another object of the present invention to provide such a computer program in which the exchange of information is not in any way limited by the ability of the lay person or member to recognize, describe and match his or her photo with that of a website or other interface image.

It is still another object of the present invention to provide such a computer program which encompasses most if not all published information on a given game photobook, such as descriptions and corresponding names of birds, insects, trees and plants or skin problems or anomalies.

It is yet 1 another object of the present invention to facilitate discussion for the open exchange of information and to promote education and academics.

It is a still another object of the present invention to provide such a computer program which allows for the publication of a real time wikiphotoatlas using the photographs identified by the board of advisors and pertinent text written by either subject matter identifiers or the credentialed board of professional advisors.

It is finally an object of the present invention to provide such a computer program which is easy to use and of maximum reliability via several different electronic media portal

### SUMMARY OF THE INVENTION

The present invention accomplishes the above-stated objectives, as well as others, as may be determined by a fair reading and interpretation of the entire specification.

A method is provided of participating in an identification game, including the steps of providing information on an interface executed by a computer program interacting with at least one and preferably several lay website visitors or other interface visitors or members of the general public, which upon joining the website or other interface are referred to herein simply as lay subject matter identifiers members, or as a lay subject submitting member who has provided the photographic image (hereinafter photo) for identification, or as an identifying member who views and submits an identification of what is shown in the photo, which in most instances would be a digital image or picture of something, to identify what specifically beyond the category of the subject matter is shown in the photo. The something in the photo requiring specific identification may fall into the any of the following categories, or into other categories one or a combination of the following categories, or into other categories such as coins, stamps, birds, cars, geographic features, guns, buildings, architecture, insects, people, plants, animals, rocks, trees, horticulture, artwork, logos, and a variety of photos captured images associated with a variety of other amateur and professionals hobbies, passions, pursuits and professions.

The method includes the essential steps of: a website or other interface visitor accessing the program on a computer; the interface visitor becoming a member of photo and text match service to gain further access to the program; the member automatically being subscribed to a photo identification queue henceforth known as the photo textmatch queue; the member generating or acquiring at least one photo of something; the member entering an identification of the content of the image of which the photo was taken; the submitting member uploading to the program the photo(s); the program assembling the photo(s) into a collection known henceforth as a photobook; the program publishing the photobook to the photo queue; the program assigning a unique identifier to the photobook, the program making the photobook anonymous by secreting the unique identifier which connects the photobook to the submitting member; the program making the photobook readable on the photo identification queue; several viewing subject matter identifier members subscribed to the photo queue retrieving the photobook from the queue; several identifying members viewing the photobook and identifying what is in the images(s) shown in the photo(s); the viewing subject matter identifier members matching identifying the photobook and therefore matching the photobook to stored texts identifying or describing the identified photo or the members simply naming what is in the photobook photos and thereby identifying or describing the identified photo image; the program storing all identified photos and associated text matches associated to the photobook; the program determining the two leading text matches or names identifying identifying names and associated text matches of what is shown in the photo as selected most frequently by the identifying members; the program publishing the photobook in combination with the two leading matched text names of the photos and associated text matches to the textmatch queue; the program notifying the submitting member that the photoidentification photoidentification and text match is complete via one of: app notification badge, account notification badge on the program driven interface, cell phone text, short message service, apple imessage, email, postal mail and telefax; submitting member viewing the identifications and textmatches associated to their photobook from the textmatch queue; the program conveying photobooks to a wiki based photo atlas for the continuing education of users, and for users to update content for points in the competition of the service as well as for potential research; the program calculating identifying member standings based on concurrence with the majority; number of photos submitted, numbers of photos identified, and for providing wiki text entries; the program identifying top rated identifying members in multiple user categories to be rewarded for participation and concurrence with the majority.

### BRIEF DESCRIPTION OF THE DRAWINGS

Various other objects, advantages, and features of the invention will become apparent to those skilled in the art from the following discussion taken in conjunction with the following drawings, in which:

FIG. 1 is an exemplary flow chart of the customer interaction with the portion of the present program in which the website or other interface visitor registers and is either rejected or becomes a member.

FIG. 2 is an exemplary flow chart of the member interaction with the portion of the present program in which the member submits a photo.

FIG. 3 is an exemplary flow chart in which the submitted photo referenced in FIG. 2 is identified and matched by lay subject matter identifiers or professional board members with descriptive text in what is referred to as a textmatch.

FIG. 4 is an exemplary flow chart in which the identified photo and associated textmatch is returned to the member together with target advertising.

FIG. 5 is an exemplary flow chart in which quality control is provided and participating members are evaluated for possible compensation.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### Method of Playing the Present On-Line Photo Identification Game

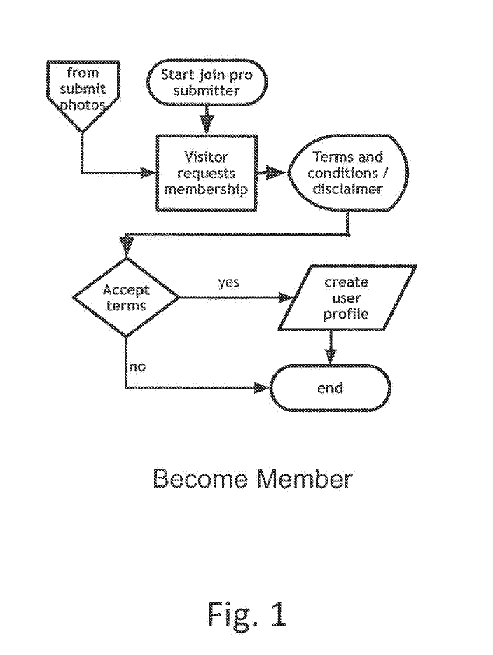

Referring to FIGS. 1-5, a method is disclosed of participating in an identification game which includes the steps of providing information on a website executed or other interface executed by a computer program interacting with at least one and preferably several lay website or other interface visitors or members of the general public, which upon joining the website or other interface are referred to herein simply as lay subject matter identifiers, or as a lay subject submitting member who has provided the photographic image (hereinafter photo) for identification, or as an identifying member who views and submits an identification of what is shown in the photo, which in most instances would be a digital image or picture of something, to identify what is shown in the photo. The something in the photo requiring specific identification may one or a combination of the following categories, or into other categories such as coins, stamps, birds, cars, geographic features, guns, buildings, architecture, insects, people, plants, animals, rocks, trees, horticulture, artwork, logos, and a variety of photos captured images associated with a variety of other amateur and professionals hobbies, passions, pursuits and professions.

The method includes the essential steps of: an interface visitor accessing the program on a computer; the interface visitor becoming a member of photo and text match service to gain further access to the program; the member automatically being subscribed to a queue henceforth known as the photo textmatch queue; the member generating or acquiring at least one photo of something; the member entering an identification of the content of the image of which the photo was taken; the submitting member uploading to the program the photo(s); the program assembling the photo(s) into a collection known henceforth as a photobook; the program publishing the photobook to the photo queue; the program assigning a unique identifier to the photobook, the program making the photobook anonymous by secreting the unique identifier which connects the photobook to the submitting member; the program making the photobook readable on the photo queue; several viewing subject matter identifier members subscribed to the photo queue retrieving the photobook from the queue; several identifying members viewing the photobook and identifying what is in the images(s) shown in the photo(s); the viewing subject matter identifier members identifying the photobook and therefore matching the photobook to stored texts identifying or describing the identified photo or the members simply naming what is in the photobook photos and thereby identifying or describing the identified photo image; the program storing all identified photos and associated text matches associated to the photobook; the program determining the two leading identifying names and associated text matches of what is shown in the photo as selected most frequently by the identifying members; the program publishing the photobook in combination with the two leading names of the photos and associated text matches to the textmatch queue; the program notifying the submitting member that the photoidentification and text match is complete via one of: app notification badge, account notification badge on the program driven interface , cell phone text, short message service, apple imessage, email, postal mail and telefax; submitting member viewing the identifications and textmatches associated to their photobook from the textmatch queue; the program conveying photobooks to a wiki based photo atlas for the continuing education of users, and for users to update content for points in the competition of the service as well as for potential research; the program calculating identifying member standings based on concurrence with the majority, number of photos submitted, numbers of photos identified, and for providing wiki text entries; the program identifying top rated identifying members in multiple user categories to be rewarded for participation and concurrence with the majority.

### Becoming a Member

Referring to FIG. 1, the basic method, including additional preferred steps, is as follows: an interface visitor such as a website visitor (visitor) accessing the program; the interface visitor requesting membership; the program displaying user terms and conditions and a disclaimer;

the visitor entering a decision of whether he or she accepts the terms and conditions and disclaimer; if the visitor rejects the terms and conditions and disclaimer, the program rejecting the visitor and ending his or her use of the program; and if the visitor accepts the terms and conditions and disclaimer; and the program creating a member profile and the visitor becoming a member.

### Submitting Photos

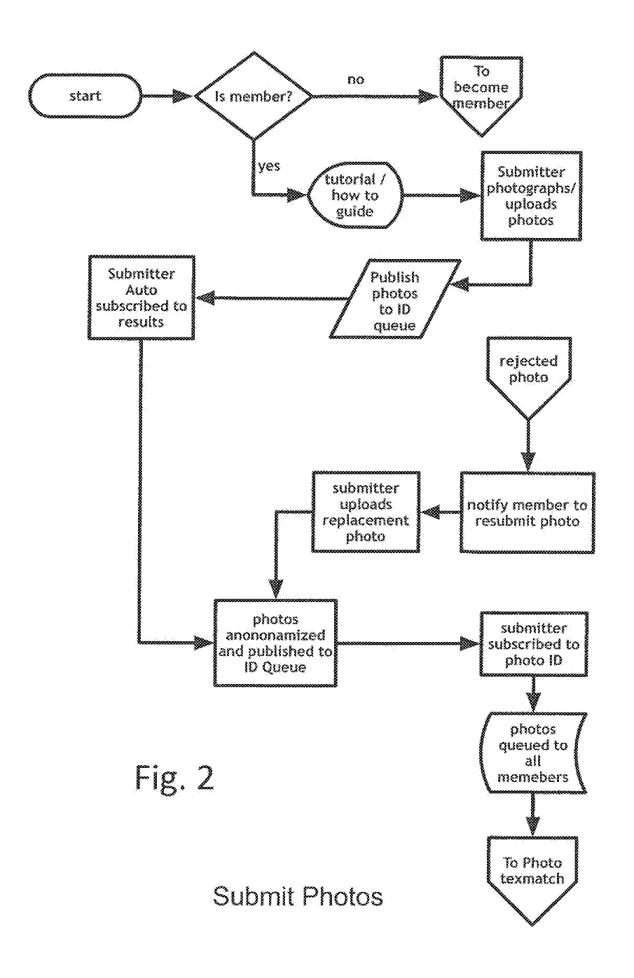

Referring to FIG. 2, an interface visitor accessing the program; the program prompting the interface visitor to submit identifying information to determine whether the interface visitor is a member; if the program determines that the interface visitor is not a member, the program directing the interface visitor to the prompt to become a member; if the program determines that the interface visitor is a member, the program prompting the member to upload at least one photo of something to be identified and thereby becoming a submitting member; the submitting member uploading to the program the photo(s); the program assembling the photo(s) into a photobook; the program publishing the photobook to the photo queue; the program assigning a unique identifier to the photobook, the program making the photobook anonymous by secreting the unique identifier which connects the photobook to the submitting member; the program making the photobook readable on the photo queue; If the photo is rejected by the majority of identifying members, the program notifying the submitting member that a photo resubmission is required; the submitting member uploading a replacement photo; if the replacement photo is acceptable, the program anonomizing and publishing the photo the ID queue; the program providing the submitting member with an image ID or textmatch; and the program proceeding to photo ID and textmatch.

### Photo Textmatch

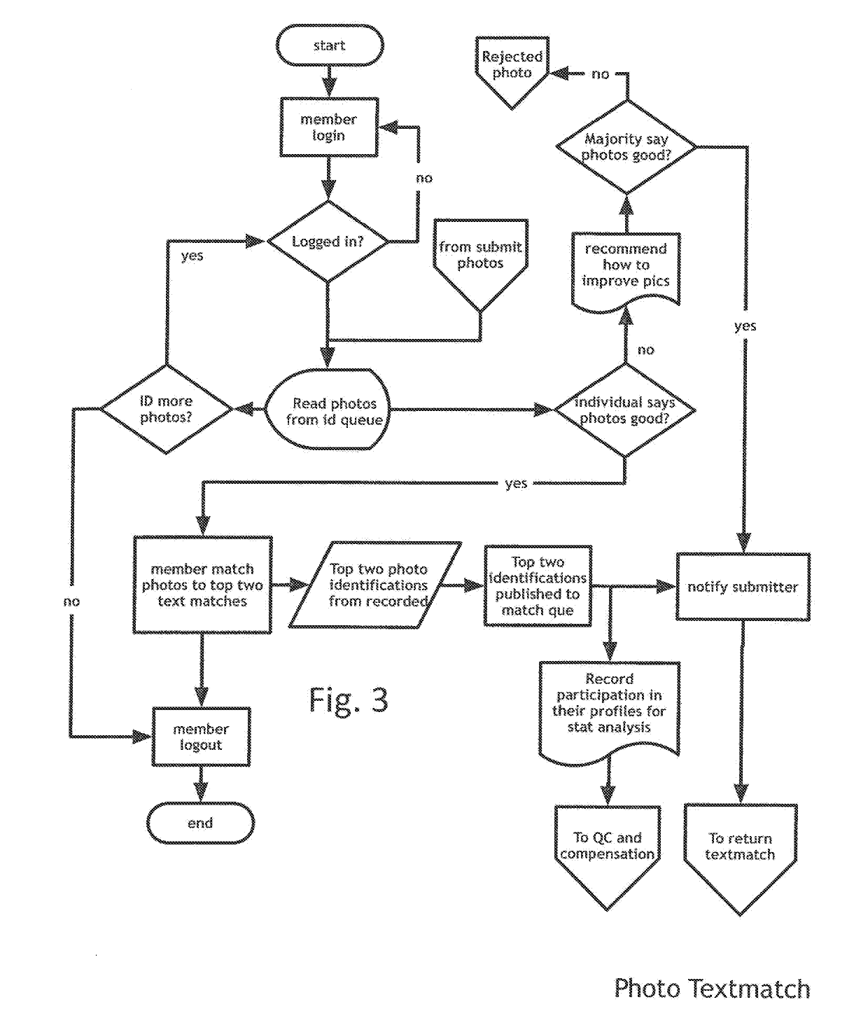

Referring to FIG. 3, if the identifying member is not logged in, the identifying member logging in; if the identifying member is logged in, the program presenting photobooks to the identifying member and the identifying member reading photobooks from the photo queue; if no more photos are to have their images identified, the member logging out, or the member logging in to read another photo; if more photos are to be identified, the identifying member determining whether the photos are good; if the identifying member determines that the photos are not good, the identifying member and program recommending how to improve the photos; the program determining whether the majority of identifying members say that the photos are good; if the majority of identifying members say that the photos are not good, the program rejecting the photo with recommendations for technical improvements; if the individual identifying member says that the photo is good, the identifying members matching the photobook to stored texts identifying or describing the identified photo or the members simply naming what is in the photobook photos; the program storing all matches associated to the photobook; the program determining the two leading text matches or names of what is shown in the photo as selected most frequently by the identifying members; the program publishing the identified photobook in combination with the two leading matched texts to the textmatch queue; the program notifying the submitting member that the identification and associated match is complete via one of: app notification badge, account notification badge on the program driven interface, cell phone text, short message service, apple imessage, email, postal mail and telefax; the program recording participation (submitting photos, identifying photos, editing wiki photo text atlas) and concurrence in their profiles for statistical analysis; the program determining quality control and optionally determining and providing reward compensation; the program placing the identified photos in the wiki based photo atlas for interface users further discussion and education.

### Return Textmatch

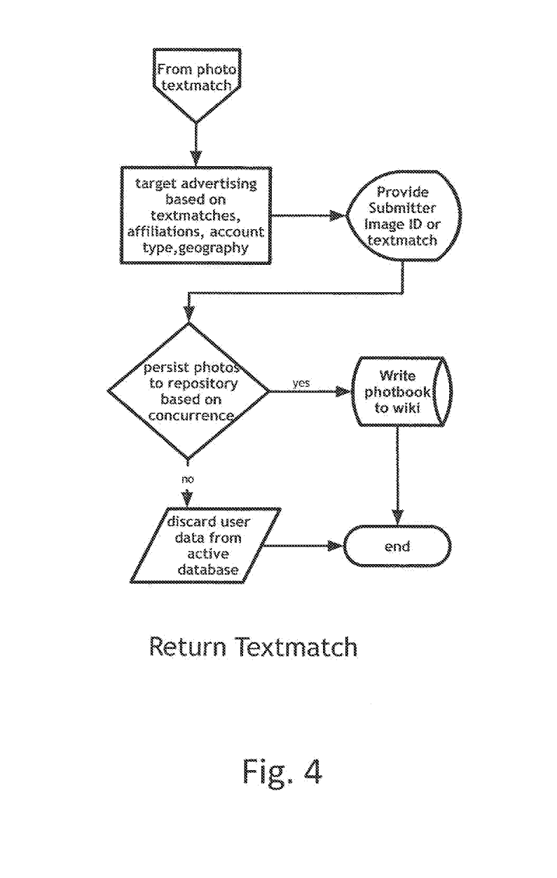

Referring to FIG. 4, proceeding from the photo atlas textmatch, the program targeting advertising based on photo identification, associated textmatches, affiliations, account type and geography; the program determining whether to send photos to the wiki based photo atlas, or in other words storing the photo in a permanent depository; if yes persist photos to wikphotoatlas repository, the program sending a photo to wiki; if no do not persist photos to repository, the program discarding user data from the online database and not conveying to a repository such as wiki based photo atlas.

### Quality Control and Compensation

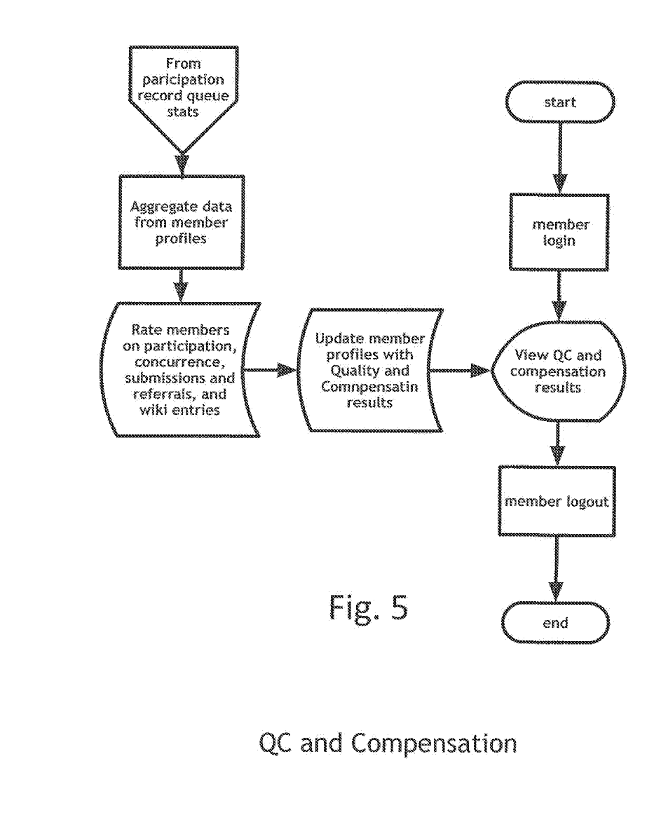

Referring to FIG. 5, data from member profiles; the program rating identifying members on frequency of participation, concurrence with the majority of identifying member votes, number of photograph submissions and referrals, and wiki based photo atlas text entries; the program optionally compensating the top identifying members or affiliates based on their ratings thereby creating an academic competition or game; the program updating identifying member profiles with rating / quality control results (concurrence with majority); the identifying member viewing quality control and any compensation results; the member logging out; the program ending his or her use of the subprogram; an identify member logging in; the identifying member viewing quality control and any competition reward compensation results; the member logs out; the program ending his or her use of the subprogram. For the above version, any member can be a submitting member, a identifying member or both.

### Variation of Method

A variation of this method is provided, which is identical to the method described above, with the following exceptions. First, in place of unrestricted lay-public members as broadly defined above submitting photos for identification and text matching, only credentialed professionals will be accepted as identifying members and thus be provided access to the interface/program to submit images. The term “professionals” can mean anyone with credentials supporting professional knowledge of the subject matter, such as researchers in the field and university professors, doctors, dentists, rocket scientists, etc. To distinguish the professionals who are provided access to the program to submit images for evaluation by the advisory board members, that is, as previously noted, professionals on the advisory board, or advisory board members, or otherwise facilitating the operation of the photo identification program, an accessing health care professional is referred to in the claims as an photo submitting health care professional and shall be credentialed accordingly by the program. It is further preferred that the photo submitting health care professionals may be identified according to those who are invited or referred, and or subsequently credentialed by the interface operators and the program to access or join this professionals-only submitting version of the website or other interface, such an invitation and credentialing being a method step and the new accessing professional shall identify the board member who referred him or her in order to reward the board member . For professional members only, the advisory board members preferably may only provide identification of what is shown in the submitted photo and optionally provide a text match. The term “identification” as used here and in the claims is understood to mean the name of the object or condition in the photo as identified by a highest number of votes of the advisory board. This is preferred because, when presented with a name of a condition represented on a photo, a photo submitting professional will understand what the name means and what the associated condition is and normally will not require an explanatory text. In addition, submitting professionals are educated in performing associated subject matter text searches related to the identified photo, unlike the lay public. Applicant does, however, contemplate the option of providing specialized matching text for the submitting professional in addition to the identification of the image or the photo. This specialized matching text preferably originates from the wiki based photo atlas long term repository constructed in croup sourced manner via the wiki web interface. The emergence of the Internet and the recent developments in online collaborative technologies has provided new tools with which to find, use, share and expand knowledge. Wiki technologies challenge the traditional notions of authorship, editing and publishing and have the inherent potential to change how we construct knowledge repositories and collaborate on the Web. Despite the extraordinary success of Wikipedia and the potential of wiki publishing, its adoption in the academic community and within the field of medical education such as in dermatology has been limited and almost non-existent. Therefore, our wiki based photo atlas is a novel educational tool.

In contrast to conventional static publications, dynamic publications in the wiki model have no final version, no definite date of publication and continuously integrate and synthesize new findings and insights. We will also develop a dynamic collaborative dermatologic knowledgebase using wiki technology that combines a continuous stream of submitted photos and merges it with referenced content created by authors from our credentialed board of advisors, with due credit given and rewarded for ongoing revisions and integration of more traditional peer review models into a rigorous clinical, educational and research tool.

Our online method will integrate a wiki based photo atlas into both our professional only and public accessed websites or other interfaces. The wiki based photo atlas will receive the photographs identified by the Board of Advisors which have been submitted to the website or other interface. Professional's only who have credentialed to participate on the Professional Board of Advisors will be able to access and edit the wikiphotoatlas text content in order to publish and continuously construct a real time, up to date collaborative dermatology or other medical specialty knowledge repository on the web. Board members who contribute to the wikiphotoatlas will be rewarded for their efforts and therefore a competition game for participation in the education information process will be created.

### An Example

The subject matter of the photo contents may be, for example, the skin, hair, mucosa or nail of either the submitting member him or herself or another person, in which the image appears to containing an anomaly requiring identification. In this instance it is preferred that the identifying member by a health care professional such as a doctor, physician's assistant, nurse, nurse practitioner or in some instances a medical technician, and these credentialed identifying members become part of the advisory board. For this example, the wikiphotoatlas is a wikiskinatlas.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A method, executed by a computer program, of participating in an identification game, comprising the steps of:
a service providing a game program accessible through an interface;
interface visitors accessing the program through an interface and becoming a plurality of photo identifying visitors and at least one photo submitting visitor;
the program receiving at least one photo from the at least one photo submitting visitor;
the program copying the photo to on-line photo identification visitors for identification;
each photo identifying visitor submitting through the interface his or her identification of what is shown in the photo;
the program determining the most common identification of what is in the photo from the identifications submitted by the participating photo identifying visitors;
and the program sending to the photo submitting visitor who submitted the given photo the most common photo identification.

2. The method of claim 1, comprising the additional steps of:
one of the visitor and the service providing a subject matter category related to the photo;
and the program receiving photos from on-line submitting visitors relating to the subject matter.

3. The method of claim 1, additionally comprising the steps of the program determining the second most common identification of what in the photo from the identifications submitted by the participating photo identifying visitors;
and the program sending to the photo submitting visitor of the given photo the second most common photo identification.

4. The method of claim 1, additionally comprising the step of the program storing the photo and at least the most common identification in a photo and text interface database.

5. The method of claim 1, additionally comprising the steps of:
the program matching explanatory text to the most common submitted identification for the given photo and sending this matched text to the photo submitting visitor who supplied the given photo.

6. The method of claim 5, wherein the matching text is drawn from the interface database.

7. A method executed by a computer program of participating in an identification game, comprising the steps of:
providing a game program accessible through an interface;
interface visitors accessing the program through an interface and becoming a plurality of photo identifying members and at least one photo submitting member;
an interface visitor accessing the program;
the interface visitor becoming a member;
the program subscribing the member to a photo identification queue;
the member one of generating and acquiring at least one photo of something;
the member uploading to the program the photo;
a plurality of identifying members interacting with the program to receive the photo;
each photo identifying member determining and providing an identification of what is shown in the photo, comprising at least one of: a name of what is shown in the photo, and a textmatch of what is shown in the photo;
the program determining the most common photo identification among the participating photo identifying members;
the program notifying the submitting member that photo identification is complete;
the program delivering the photo identification to the submitting member;
and the submitting member viewing the photo identification.

8. The method of claim 7, wherein the member one of generating and acquiring at least one photo of something within a subject matter category; and the member entering information indicating the photo subject matter category;

9. The method of claim 7, wherein the photo identification is one of a name of what is shown in the photo and a textmatch in the form of a text of information of what is in the photo.

10. The method of claim 7, comprising the additional steps of:
the program assembling the photo into a collection known in the as form of a photobook;
the program publishing the photobook to the photo identification queue;
the program assigning a unique identifier to the photobook;
the program making the photobook anonymous by secreting the unique identifier which connects the photobook to the submitting member;
the program making the photobook readable on the photo identification queue;
the photo identifying members subscribing to the photo queue retrieving the photobook from the queue;
the photo identifying members viewing the photobook to identify what is shown in the image in the photo.

11. The method of claim 10, comprising the additional steps of:
the photo identifying members what is shown in the photo in the photobook to stored texts which one of identify and describe the identified photo;
the program storing in a data depository all photo identifications to the photobook;
and the program publishing the photobook in combination with the leading matched text name of what is shown in the the photo and associated text match to the textmatch queue.

12. The method of claim 7, wherein the program notifies the submitting member that the photo identification is complete via one of: app notification badge, account notification badge on the program driven interface, cell phone text, short message service, apple imessage, email, postal mail and telefax.

13. The method of claim 7, comprising the additional steps of:
the program providing each member with a photobook;
the submitting member viewing the photo identifications associated to their photobook from the photo identification queue;
and the program conveying the photobook to a data depository.

14. The method of claim 13, wherein the data depository comprises a wiki based photo atlas.

15. The method of claim 13, comprising the additional step of:
the program identifying top rated identifying members in multiple user categories to be rewarded based on at least one of: frequency of participation, concurrence with the majority the number of photos they submit, the number of photos they identify, and the number of wiki text entries.

16. The method of claim 7, wherein becoming a member comprises the steps of:
an interface visitor accessing the program;
the visitor requesting membership;
the program displaying user terms and conditions and a disclaimer;
the visitor entering a decision of whether he or she accepts the terms and conditions and disclaimer;
if the visitor rejects the terms and conditions and disclaimer, the program rejecting the visitor and ending his or her use of the program;
and if the visitor accepts the terms and conditions and disclaimer, the program creating a member profile and the visitor becoming a member.

17. The method of claim 7, wherein the interface is a website and wherein the interface visitor is a website visitor.

18. The method of claim 7, wherein submitting a photo comprises the steps of:
an interface visitor accessing the program;
the program prompting the interface visitor to submit identifying information to establish whether the interface visitor is a member;
if the program determines that the website visitor is not a member, the program directing the interface visitor to the prompt to become a member;
if the program determines that the interface visitor is a member, the program prompting the member to upload at least one photo of something to be identified and thereby becoming a submitting member; the submitting member uploading to the program the photo;
the program placing the photo into a photobook;
the program publishing the photobook to the photo queue;
the program assigning a unique identifier to the photobook;
the program making the photobook anonymous by secreting the unique identifier which connects the photobook to the submitting member;
the program making the photobook readable on the photo queue;
if the photo is rejected by the majority of identifying members, the program notifying the submitting member that a photo resubmission is required;
the submitting member uploading a replacement photo;
if the replacement photo is acceptable, the program anonomizing and publishing the photo in the photo identification queue;
the photo identifying members providing the program with a photo identification;
and the program proceeding to photo identification.

19. The method of claim 18, wherein, if the program determines that the interface visitor is a member, the program prompts the member to upload at least one photo of something to be identified as well as a subject matter category and thereby becoming a submitting member.

20. The method of claim 18, comprising the step of providing a textmatch with photo identification.

21. The method of claim 10, wherein providing a photo textmatch comprises the steps of:
a plurality of identifying members logging in;
the program presenting photo to the identifying members;
the identifying members evaluating the photo;
if no more photos are to have their images identified, the photo submitting member one of logging out and logging in to read another photo;
if more photos are to be identified, each photo identifying member determining whether the photo is good;
if the identifying member determines that the photo is not good, the at least one identifying member and the program recommending how to improve the photo;
the program determining whether the majority of identifying members say that the photo is good;
if the majority of identifying members say that the photo is not good, the program rejecting the photo with at least one recommendations for technical improvement of the photo;
if the individual photo identifying member says that the photo is good, the identifying members each providing a photo identification;
the program storing all names and matches associated to the photo;
the program determining the leading photo identification as selected most frequently by the photo identifying members;
and the program notifying the submitting member that the match is complete.

22. The method of claim of claim 21, wherein the program presenting photo by presenting a photobook to the identifying members; wherein the identifying members evaluate the photo by reading photobooks from the photo queue; and wherein the program stores all names and matches associated to the photobook;
comprising the additional step of the program publishing the named photobook in combination with a leading match text to the textmatch queue.

23. The method of claim 21, comprising the additional step of the program recording participation and concurrence in their profiles for statistical analysis;

24. The method of claim 21, comprising the additional step of the program determining quality control.

25. The method of claim 21, comprising the additional step of the program placing the identified photos in the wiki based photo atlas for interface users further discussion and education.

26. The method of claim 11, wherein the program notifies the submitting member that the match is complete via one of: app notification badge, account notification badge on the program driven website or other interface, cell phone text, short message service, apple imessage, email, postal mail and telefax.

27. The method of claim 7, wherein returning a textmatch comprises the steps of:
the program targeting advertising to interface members based on at least one of member photo identification, member associated textmatches, member affiliations, member account type and member geography.

28. The method of claim 7, comprising the additional steps of:
providing an interface depository;
the program determining whether to send a photo to the interface depository to be stored;
and the program one of sending a photo to the interface depository and not sending the photo to the interface depository.

29. The method of claim 28, wherein the interface depository is a permanent depository.

30. The method of claim 29, wherein the permanent depository is a wiki based photo atlas.

31. The method of claim 24, wherein providing quality control, comprising the steps of:
the program rating photo identifying members according to frequency of their participation, concurrence with the majority of identifying members in photo identification, number of photograph submissions and referrals from the identifying member, and wiki based photo atlas text entries by the identifying member;
and the program compensating the top identifying members or affiliates based on their ratings thereby creating a competition.

32. The method of claim 31, comprising the additional steps of:
the program updating identifying member profiles with one of rating and quality control results;
the member viewing quality control and compensation results;
the member logging out;
the program ending his or her use of the subprogram;
a viewing member logging in;
the viewing member viewing quality control and competition reward compensation results;
the member logs out;
and the program ending his or her use of the subprogram.

33. The method of claim 32, wherein the one of rating and quality control results is the degree of concurrence with other identifying members.

34. The method of claim 7, comprising the steps of:
identifying members who are credentialed professionals;
and permitting only the credentialed professionals to become identifying members.

35. The method of claim 7, comprising the steps of:
identifying credentialed professionals among interface visitors who apply to become members;
permitting only credentialed professionals to become members.

36. The method of claim 34, wherein a credentialed professional is defined as anyone having credentials supporting professional knowledge of photo subject matter to be indentified.

37. The method of claim 34, wherein at least some credentialed professionals are identified by one of invited to become photo identifying members and are referred to the interface by a person on a list of qualified referring people.

38. The method of claim 35, wherein a credentialed professional is defined as anyone having credentials supporting professional knowledge of photo subject matter to be indentified.

39. The method of claim 35, wherein at least some credentialed professionals are identified by one of invited to become photo identifying members and are referred to the interface by a person on a list of qualified referring people.

40. The method of claim 34, wherein photo identification involves providing a name of what is shown in a photo.

41. The method of claim 40, wherein photo identification additionally comprises matching the name of what is shown in the photo to text in an interface data depository.

42. The method of claim 41, wherein the interface data depository is a wiki based photo atlas.

43. The method of claim 35, wherein photo identification involves providing a name of what is shown in a photo.

44. The method of claim 43, wherein photo identification additionally comprises matching the name of what is shown in the photo to text in an interface data depository.

45. The method of claim 44, wherein the interface data depository is a wiki based photo atlas.

46. The method of claim 1, wherein the interface comprises a computer.

47. The method of claim 7, wherein the interface comprises a computer.

48. The method of claim 1, comprising the additional steps of:
the program rating photo identifying members according to frequency of their participation, concurrence with the majority of identifying members in photo identification, number of photograph submissions and referrals from the identifying member, and wiki based photo atlas text entries by the identifying member;
and the program compensating the top identifying members or affiliates based on their ratings thereby creating a competition.

49. The method of claim 7, comprising the additional steps of:
the program rating photo identifying members according to frequency of their participation, concurrence with the majority of identifying members in photo identification, number of photograph submissions and referrals from the identifying member, and wiki based photo atlas text entries by the identifying member;
and the program compensating the top identifying members or affiliates based on their ratings thereby creating a competition.
